(19) United States
(12) Patent Application Publication
(10) Pub. No.: US 2025/0385416 A1
(43) Pub. Date: Dec. 18, 2025

(54) FIBER-COUPLED TERAHERTZ RF TRANSCEIVER SYSTEM HAVING AN AIR DIELECTRIC TWINAX

(71) Applicant: Attotude, Inc, Menlo Park, CA (US)

(72) Inventors: Joy Laskar, Mountain View, CA (US); David F. Welch, Atherton, CA (US)

(21) Appl. No.: 19/239,358

(22) Filed: Jun. 16, 2025

Related U.S. Application Data
(60) Provisional application No. 63/660,152, filed on Jun. 14, 2024.

(51) Int. Cl. H01P 3/02; H01Q 21/00

(52) U.S. Cl. CPC H01P 3/02; H01Q 21/0006

(57) ABSTRACT

Systems and methods include a twinaxial waveguide, comprising a sidewall, first and second supports, and first and second conductors. The sidewall has first and second sides, first and second ends, a longitudinal axis extending between the first and second ends, and outer and inner surfaces. The inner surface surrounds a waveguide core extending between the first and second ends. The first support extends between the first and second ends on the first side. The second support extends between the first and second ends on the second side. The first conductor extends along the longitudinal axis between the first and second ends of the sidewall and is supported by the first support. The second conductor extends along the longitudinal axis between the first and second ends of the sidewall and is supported by the second support. The waveguide core extends between the first and second conductors.

### CROSS-REFERENCE TO RELATED APPLICATIONS

This application claims priority to the provisional patent application identified by U.S. Ser. No. 63/660,152, filed Jun. 14, 2024, the entire content of which is hereby expressly incorporated herein by reference.

### BACKGROUND OF THE INVENTION

In the field of data communications, the demand for higher data rates and improved signal integrity is ever-increasing. High-speed data transmission systems, such as those found in data centers utilizing “flyover” cables, rely on high-performance cabling to transmit signals with minimal loss, distortion, and interference. Twinaxial cable, often referred to as “twinax,” is a type of electrical cable commonly used for these short-range, high-speed differential signaling applications.

A typical twinaxial cable comprises a pair of parallel inner conductors. These conductors are encased in a solid dielectric material, such as polytetrafluoroethylene (PTFE), which provides insulation and maintains a specific distance between them, thereby defining the cable's characteristic impedance. Surrounding the dielectric is a conductive shield, and the entire assembly is enclosed in a protective outer jacket.

While this construction is suitable for conventional baseband signaling-where a broadband signal from DC to an upper frequency limit is transmitted-it presents fundamental limitations that make it unsuitable for emerging high-frequency, carrier-based communication systems, such as those operating in the Terahertz (THz) range.

One limitation of conventional twinax is that the signal's propagation characteristics are dominated by the solid dielectric material. As a high-frequency signal propagates, the solid insulating material absorbs a significant portion of the signal's energy, converting it into heat. This dielectric loss severely attenuates high-frequency carriers, preventing them from being transmitted effectively. Similarly, the dielectric material significantly slows the signal's transit through the cable, increasing latency.

Beyond these inherent electrical limitations, the reliance on a solid dielectric core introduces significant mechanical and manufacturing challenges. The solid dielectric is prone to deformation during manufacturing or distortion when the cable is bent or handled. Any such change in the physical shape of the dielectric alters the precise spacing between the inner conductors, which in turn causes an unpredictable change in the cable's characteristic impedance. This unpredictability degrades signal integrity and can lead to lower manufacturing yields and inconsistent field performance.

Furthermore, existing twinax cables are designed to carry broadband signals and are already approaching their performance limits for these applications. They are fundamentally not designed to support the propagation of signals modulated onto a high-frequency carrier, as the dielectric loss at such carrier frequencies is prohibitive.

Therefore, there exists a desire in the art for a transmission structure that overcomes the limitations of conventional, solid-dielectric twinax cables. A structure capable of efficiently propagating a high-frequency, carrier-modulated signal, while also addressing the mechanical instability and manufacturing difficulties inherent in solid-core designs, would represent a significant advancement in the field of high-speed data transmission.

### SUMMARY OF THE INVENTION

The present disclosure provides a twinaxial waveguide structure that overcomes the limitations of conventional solid-dielectric cables, enabling the efficient propagation of high-frequency, carrier-modulated signals. The disclosure addresses the problems of high dielectric loss, reduced signal velocity, and mechanical instability inherent in prior art designs by providing a structure where the signal propagation path is primarily through a low-loss air core.

This disclosure provides a twinaxial waveguide having a sidewall that encloses a waveguide core. A first conductor and a second conductor are positioned within the waveguide core and held in place by minimal support structures extending from the sidewall. This configuration creates a dominant air dielectric in the region between and around the two conductors. By maximizing the portion of the waveguide core filled with air, the deleterious effects associated with solid dielectric materials are minimized. This results in significantly lower signal attenuation and a higher velocity of propagation compared to conventional twinax cables where the signal's characteristics are dominated by a solid dielectric like PTFE.

The structure of the disclosure is configured to support at least two distinct modes of operation.

In a first mode of operation, the waveguide can function as a high-performance replacement for conventional twinaxial cables. A differential electrical signal, such as a baseband signal or a signal modulated on a carrier, can be applied directly to the first and second conductors. In this configuration, the waveguide provides a lower-loss, higher-speed transmission medium than what is achievable with solid-core designs.

In a second mode of operation, the waveguide is configured to support the propagation of a high-frequency, carrier-modulated signal, such as a signal in the THz range. In this mode, an antenna or other coupling element can be used to introduce a radiated signal into the waveguide core. The first and second conductors, along with the sidewall, act to guide the radiated signal, allowing for efficient, low-loss transmission. This mode enables communication at carrier frequencies that are not supportable by conventional twinax cables due to prohibitive dielectric losses.

By providing a versatile structure that minimizes reliance on solid dielectrics, the present invention offers a robust solution for next-generation data transmission. It overcomes the electrical and mechanical performance limits of existing cables and provides a pathway for utilizing high-frequency carrier-based communication in various applications.

In one aspect, the present disclosure includes a twinaxial waveguide, comprising: a sidewall having a first side, a second side, a first end, a second end, a longitudinal axis extending between the first end and the second end, an outer surface, and an inner surface surrounding a waveguide core extending between the first end and the second end; a first support extending between the first end and the second end on the first side; a second support extending between the first end and the second end on the second side; a first conductor extending along the longitudinal axis between the first end and the second end of the sidewall, the first conductor being supported by the first support; and a second conductor extending along the longitudinal axis between the first end and the second end of the sidewall, the second conductor being supported by the second support; wherein the waveguide core extends between the first conductor and the second conductor.

In another aspect, the present disclosure includes a transport network, comprising: a twinaxial waveguide, comprising: a sidewall having a first side, a second side, a first end, a second end, a longitudinal axis extending between the first end and the second end, an outer surface, and an inner surface surrounding a waveguide core extending between the first end and the second end;

a first support extending between the first end and the second end on the first side; a second support extending between the first end and the second end on the second side; a first conductor extending along the longitudinal axis between the first end and the second end of the sidewall, the first conductor being supported by the first support; and a second conductor extending along the longitudinal axis between the first end and the second end of the sidewall, the second conductor being supported by the second support; wherein the waveguide core extends between the first conductor and the second conductor; a first network element comprising a transmitter operatively coupled to the first end of the twinaxial waveguide, the transmitter being operable to provide an electromagnetic signal to the first end of the twinaxial waveguide; and a second network element comprising a receiver operatively coupled to the second end of the twinaxial waveguide, the receiver being operable to receive the electromagnetic signal from the second end of the twinaxial waveguide.

The foregoing summary provides an overview of certain selected embodiments or embodiments disclosed herein, and is not intended to describe every aspect, embodiment, embodiment, feature, or advantage of the disclosure exhaustively or comprehensively. Therefore, this summary should not be construed in such a way to limit the scope of this disclosure or to limit the scope of the claims. The details of one or more embodiment or embodiment disclosed herein are set forth in the accompanying drawings and descriptions below. Other aspects, features, embodiments, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more embodiments of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a frequency-wavelength diagram of the electromagnetic (EM) spectrum;

FIG. 2 is a block diagram of an exemplary embodiment of a transport network constructed in accordance with the present disclosure;

FIG. 3 is a block diagram of an exemplary embodiment of a user device of the transport network shown in FIG. 2;

FIG. 4 is a block diagram of an exemplary embodiment of a network administrator device of the transport network shown in FIG. 2;

FIG. 5 is a block diagram of an exemplary embodiment of a first network element of the transport network shown in FIG. 2;

FIG. 6 is a block diagram of an exemplary embodiment of a transport network link comprising a twinaxial waveguide structure constructed in accordance with the present disclosure;

FIG. 7A is a cross-sectional view of an exemplary embodiment of the twinaxial waveguide structure shown in FIG. 6, taken along the line 7-7 and in the direction of the arrows;

FIG. 7B is a cross-sectional view of another exemplary embodiment of the twinaxial waveguide structure shown in FIG. 6, taken along the line 7-7 and in the direction of the arrows, wherein a sidewall of the twinaxial waveguide structure is constructed of a conductive material; and

FIG. 7C is a cross-sectional view of an exemplary embodiment of the twinaxial waveguide structure shown in FIG. 6, taken along the line 7-7 and in the direction of the arrows, wherein the sidewall of the twinaxial waveguide structure is a layered structure having a conductive layer and a dielectric layer.

### DETAILED DESCRIPTION

The following detailed description refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

As used herein, “circuitry” may refer to analog and/or digital components, or one or more suitably programmed processors (e.g., microprocessors) and associated hardware and software, or hardwired logic. Also, “circuitry” may perform one or more functions. The term “circuitry” may include hardware, such as a processor (e.g., microprocessor), a combination of hardware and software, and/or the like. Software may include one or more processor-executable instructions that when executed by one or more processors cause the one or more processors to perform a specified function. It should be understood that the algorithms described herein may be stored on one or more non-transitory memories. Exemplary non-transitory memory may include random access memory, read only memory, flash memory, and/or the like. Such non-transitory memory may be electrically based, optically based, and/or the like.

As used herein, “software” may include one or more computer readable instructions that when executed by one or more component (e.g., a processor) causes the component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, a phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

As used herein, a “mode” refers to a unique distribution of electric and magnetic fields which repeat along the length of a passive waveguide by which electromagnetic energy may be transported through the passive waveguide. “Single-mode” refers to a passive waveguide designed to carry only one mode of electromagnetic wave. This is achieved by having a narrow core diameter, which allows only one mode of light to propagate at a time. On the other hand, “multi-mode” refers to a passive waveguide designed to carry multiple modes of electromagnetic waves simultaneously. This is possible due to its larger core diameter, which enables multiple modes to be propagated.

As used herein, “passive waveguide” refers to a structure that guides electromagnetic waves by restricting transmission of energy in a particular direction. In the context of the present disclosure, “passive waveguide” may refer to an optical fiber having a waveguide core operable to propagate RF signals in the THz frequency band or a routed waveguide operable to propagate RF signals in the THz frequency band.

As used herein, “diameter” refers to a straight line passing from side to side through the center of a body or figure. In some embodiments, the body or figure has a circular shape having a single diameter or an elliptical shape having multiple different diameters.

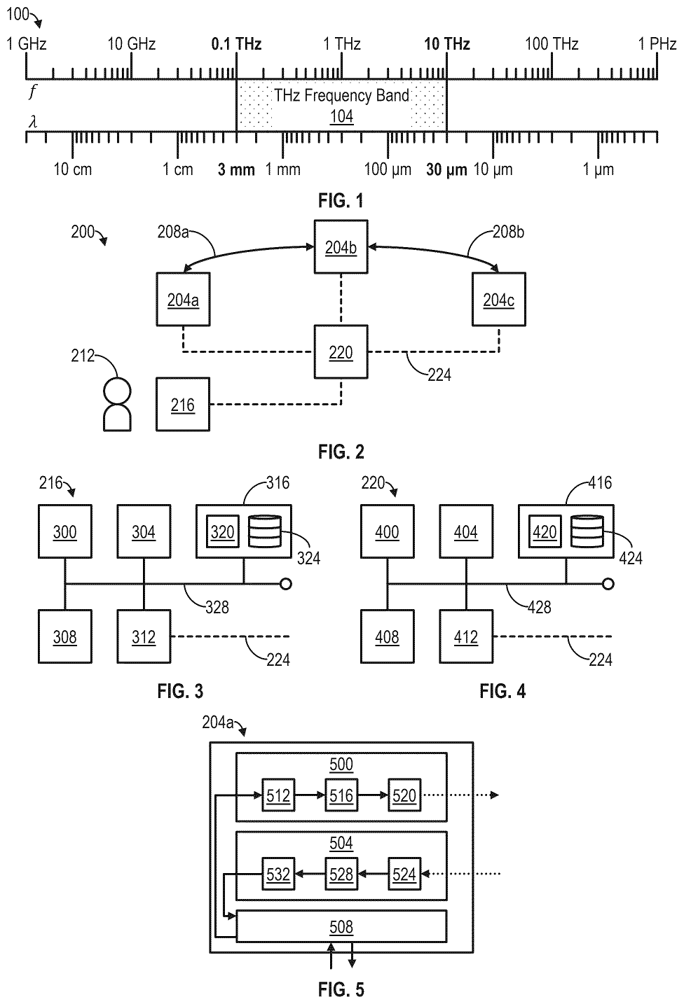

Referring now to the drawings, and in particular to FIG. 1, shown therein is a frequency-wavelength diagram of the electromagnetic (EM) spectrum 100. As shown in FIG. 1, frequency and wavelength have an inverse relationship; that is, as the frequency of a signal increases, the wavelength of the signal decreases, and vice versa. The present disclosure is generally related to transport networks (shown in FIG. 2) and network elements (shown in FIG. 2) that communicate using signals comprising radiated electromagnetic waves coupled into passive waveguides. Such signals generally have a frequency in what is referred to as the Terahertz (THz) frequency band 104, which corresponds to frequencies in a range between 0.1 THz and 10 THz and wavelengths in a range between 3 millimeters (mm) and 30 micrometers (μm). However, in some embodiments, the signals may have a frequency in a different range, such as between 300 Gigahertz (GHz) and 10 THz, for example.

Referring now to FIG. 2, shown therein is a block diagram of an exemplary embodiment of a transport network 200 constructed in accordance with the present disclosure. As shown in FIG. 2, the transport network 200 generally comprises a plurality of network elements 204a-n (hereinafter, the “network elements 204”) (e.g., a first network element 204a, a second network element 204b, and a third network element 204c shown in FIG. 2) which may communicate with each other using one or more passive waveguides 208a-n (hereinafter, the “passive waveguides 208”) (e.g., a first passive waveguide 208a and a second passive waveguide 208b shown in FIG. 2).

While three of the network elements 204 are shown in FIG. 2, it should be understood that the transport network 200 may comprise a number of the network elements 204 that is greater or less than three. Further, while two of the passive waveguides 208 are shown in FIG. 2, it should be understood that the transport network 200 may comprise a number of the passive waveguides 208 that is greater or less than two.

In some embodiments of the transport network 200, a user 212 may interact with the transport network 200 using a user device 216 that may be used to request, such as from a network administrator device 220, a user interface application (shown in FIG. 3) which may be operable to accept input from the user 212 which may be transmitted to at least one of the network elements 204. In some such embodiments, the network administrator device 220 may be connected to the transport network 200 and the user device 216 via a communication network 224.

The communication network 224 may interface by optical and/or electronic interfaces and/or use a variety of network topographies and/or protocols to permit bidirectional interface and/or communication of signals and/or data between the network elements 204, the user device 216, and the network administrator device 220. In some embodiments, the communication network 224 may also be formed at least partially within one or more of the passive waveguides 208. The communication network 224 may interface with the network elements 204, the user device 216, and the network administrator device 220 in a variety of ways. For example, in some embodiments, the communication network 224 may be the World Wide Web (i.e., the Internet). In some such embodiments, a user interface of the transport network 200 may be delivered through a series of web pages or private internal web pages of a company or corporation, which may be written in Hypertext Markup Language (HTML), Hypertext Preprocessor (PHP), or Javascript, for example, and may be accessible by the user device 216. It should be noted that the user interface of the transport network 200 may be another type of interface including, but not limited to, a Windows-based application, a server-based application, a tablet-based application, a mobile web interface, an application running on a mobile device, a virtual-reality interface, an augmented-reality interface, and/or the like.

While the communication network 224 is described above as being the World Wide Web (i.e., the Internet), it should be noted that the communication network 224 may be almost any type of network and may be implemented as a Local Area Network (LAN), a Wide-Area Network (WAN), a Low-Power Wide-Area Network (LPWAN), a Long Range (LoRa) network, a metropolitan network, a wireless network, a Wi-Fi network, a cellular network, a Bluetooth network, a Global System for Mobile Communications (GSM) network, a Code Division Multiple Access (CDMA) network, a Third Generation (3G) network, a Fourth Generation (4G) network, a Long Term Evolution (LTE) network, a Fifth Generation (5G) network, a satellite network, a radio network, an optical network, a cable network, a public switched telephone network, an Ethernet network, a short-wave wireless network, a long-wave wireless network, combinations thereof, and/or the like.

The number of devices and/or networks illustrated in FIG. 2 is provided for explanatory purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200. Devices of the transport network 200 may interconnect via wired connections, wireless connections, or a combination thereof.

Referring now to FIG. 3, shown therein is a block diagram of an exemplary embodiment of the user device 216 of the transport network 200 constructed in accordance with the present disclosure. In some embodiments, the user device 216 may include, but is not limited to, embodiment as a personal computer, a cellular telephone, a smart phone, a network-capable television set, a tablet, a laptop computer, a desktop computer, a network-capable handheld device, a server, a digital video recorder, a wearable network-capable device, a virtual reality (VR)/augmented reality (AR) device, and/or the like.

As shown in FIG. 3, the user device 216 generally includes one or more user input devices 300a-n (hereinafter, the “user input device 300”), one or more user output devices 304a-n (hereinafter, the “user output device 304”), one or more user processors 308a-n (hereinafter, the “user processor 308”), one or more user communication devices 312a-n (hereinafter, the “user communication device 312”), and one or more user memories 316a-n (hereinafter, the “user memory 316”) storing one or more user software applications 320a-n (hereinafter, the “user software application 320”), comprising processor-executable instructions, and/or one or more user databases 324a-n (hereinafter, the “user database 324”). The user input device 300, the user output device 304, the user processor 308, the user communication device 312, and the user memory 316 may be connected via a user path 328 such as a data bus that permits communication among the components of the user device 216.

The user input device 300 may be capable of receiving information input from the user processor 308 and/or the user 212, and transmitting such information to other components of the user device 216 and/or the communication network 224. The user input device 300 may include, but is not limited to, embodiment as a keyboard, a touchscreen, a mouse, a trackball, a microphone, a camera, a fingerprint reader, an infrared port, an optical port, a cell phone, a smart phone, a Personal Digital Assistant (PDA), a remote control, a fax machine, a wearable communication device, a network interface, combinations thereof, and/or the like, for example.

The user output device 304 may be capable of outputting information in a form perceivable by the user processor 308 and/or the user 212. The user output device 304 may include, but is not limited to, embodiment as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the user input device 300 and the user output device 304 may be implemented as a single device, such as, for example, a touchscreen of a computer, a tablet, or a smartphone. It is to be further understood that as used herein the term “user” (i.e., the user 212) is not limited to a human being, and may comprise a computer, a server, a website, a processor, a network interface, a user terminal, a virtual computer, combinations thereof, and/or the like, for example. The user output device 304 may display the user interface on the user device 216.

The user processor 308 may include, but is not limited to, embodiment as a processor, a microprocessor, a mobile processor, a System on a Chip (SoC), a Central Processing Unit (CPU), a Microcontroller (MCU), a Digital Signal Processor (DSP), an Application Specific Integrated Circuit (ASIC), a Field Programmable Gate Array (FPGA), a Tensor Processing Unit (TPU), a Graphics Processing Unit (GPU), a Neural Processing Unit (NPU), a combination of hardware and software, and/or the like. The user processor 308 may be capable of communicating with the user input device 300, the user output device 304, the user communication device 312, and/or the user memory 316 via the user path 328. The user processor 308 may include one or more of the user processor 308 working together or independently and located locally or remotely (e.g., accessible via the communication network 224).

The user communication device 312, in communication with the user processor 308, may interface with the communication network 224. For example, the user processor 308 may be capable of communicating via the communication network 224 by exchanging signals (e.g., analog, digital, optical, and/or the like) via one or more ports (e.g., physical or virtual ports) using a network protocol to communicate signals and/or data with the network administrator device 220 and/or transport network 200.

The user memory 316 may comprise one or more non-transitory processor-readable media. The user memory 316 may store the user software application 320 that, when executed by the user processor 308, causes the user device 216 to perform an action such as communicate with or control one or more component of the user device 216 and/or, via the communication network 224, the transport network 200. The user memory 316 may include one or more of the user memory 316 working together or independently to store processor-executable code and may be located locally or remotely (e.g., accessible via the communication network 224). The user software application 320 may include, for example, a web browser capable of accessing a website and/or communicating signals and/or data over a wireless or wired network (e.g., the communication network 224) and/or the like.

The user database 324 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The user database 324 may be centralized or distributed across multiple systems.

The number of devices and/or networks illustrated in FIG. 3 is provided for explanatory purposes. In practice, there may be additional devices and/or networks, fewer devices and/or networks, different devices and/or networks, or differently arranged devices and/or networks than are shown in FIG. 3. Furthermore, two or more of the components or devices illustrated in FIG. 3 may be implemented within a single component or device, or a single component or device illustrated in FIG. 3 may be implemented as multiple, distributed components or devices. Additionally, or alternatively, one or more of the components or devices of the user device 216 may perform one or more functions described as being performed by another one or more of the components or devices of the user device 216. Components or devices of the user device 216 may interconnect via wired connections, wireless connections, or a combination thereof. For example, in one embodiment, the user device 216 and the network administrator device 220 may be integrated into the same device; that is, the user device 216 may perform functions and/or processes described as being performed by the network administrator device 220, described in more detail below.

Referring now to FIG. 4, shown therein is a block diagram of an exemplary embodiment of the network administrator device 220 of the transport network 200 constructed in accordance with the present disclosure. In some embodiments, the network administrator device 220 may include, but is not limited to, embodiment as a personal computer, a cellular telephone, a smart phone, a network-capable television set, a tablet, a laptop computer, a desktop computer, a network-capable handheld device, a server, a digital video recorder, a wearable network-capable device, a VR/AR device, and/or the like.

As shown in FIG. 4, the network administrator device 220 generally includes one or more administrator input devices 400a-n (hereinafter, the “administrator input device 400”), one or more administrator output devices 404a-n (hereinafter, the “administrator output device 404”), one or more administrator processors 408a-n (hereinafter, the “administrator processor 408”), one or more administrator communication devices 412a-n (hereinafter, the “administrator communication device 412”), and one or more administrator memories 416a-n (hereinafter, the “administrator memory 416”) storing one or more administrator software applications 420a-n (hereinafter, the “administrator software application 420”) comprising processor-executable instructions and/or one or more administrator databases 424a-n (hereinafter, the “administrator database 424”). The administrator input device 400, the administrator output device 404, the administrator processor 408, the administrator communication device 412, and the administrator memory 416 may be connected via an administrator path 428 such as a data bus that permits communication among the components of the network administrator device 220.

The administrator input device 400 may be capable of receiving information input from the administrator processor 408 and/or the user 212, and transmitting such information to other components of the network administrator device 220 and/or the communication network 224. The administrator input device 400 may include, but is not limited to, embodiment as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The administrator output device 404 may be capable of outputting information in a form perceivable by the administrator processor 408 and/or the user 212. The administrator output device 404 may include, but is not limited to, embodiment as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the administrator input device 400 and the administrator output device 404 may be implemented as a single device, such as, for example, a touchscreen of a computer, a tablet, or a smartphone. The administrator output device 404 may display the user interface on the network administrator device 220.

The administrator processor 408 may include, but is not limited to, embodiment as a processor, a microprocessor, a mobile processor, an SoC, a CPU, an MCU, a DSP, an ASIC, an FPGA, a TPU, a GPU, an NPU, a combination of hardware and software, and/or the like. The administrator processor 408 may be capable of communicating with the administrator input device 400, the administrator output device 404, the administrator communication device 412, and/or the administrator memory 416 via the administrator path 428. The administrator processor 408 may include one or more of the administrator processor 408 working together or independently and located locally or remotely (e.g., accessible via the communication network 224).

The administrator communication device 412, in communication with the administrator processor 408, may interface with the communication network 224. For example, the administrator processor 408 may be capable of communicating via the communication network 224 by exchanging signals (e.g., analog, digital, optical, and/or the like) via one or more ports (e.g., physical or virtual ports) using a network protocol to communicate signals and/or data with the user device 216 and/or the transport network 200.

The administrator memory 416 may comprise one or more non-transitory processor-readable media. The administrator memory 416 may store the administrator software application 420 that, when executed by the administrator processor 408, causes the network administrator device 220 to perform an action such as communicate with or control one or more component of the network administrator device 220 and/or, via the communication network 224, the transport network 200. The administrator memory 416 may include one or more of the administrator memory 416 working together or independently to store processor-executable code and may be located locally or remotely (e.g., accessible via the communication network 224). The administrator software application 420 may include, for example, a web browser capable of accessing a website and/or communicating signals and/or data over a wireless or wired network (e.g., the communication network 224) and/or the like.

The administrator database 424 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The administrator database 424 may be centralized or distributed across multiple systems.

The number of devices and/or networks illustrated in FIG. 4 is provided for explanatory purposes. In practice, there may be additional devices and/or networks, fewer devices and/or networks, different devices and/or networks, or differently arranged devices and/or networks than are shown in FIG. 4. Furthermore, two or more of the components or devices illustrated in FIG. 4 may be implemented within a single component or device, or a single component or device illustrated in FIG. 4 may be implemented as multiple, distributed components or devices. Additionally, or alternatively, one or more of the components or devices of the network administrator device 220 may perform one or more functions described as being performed by another one or more of the components or devices of the network administrator device 220. Components or devices of the network administrator device 220 may interconnect via wired connections, wireless connections, or a combination thereof. For example, in one embodiment, the network administrator device 220 and the user device 216 may be integrated into the same device; that is, the network administrator device 220 may perform functions and/or processes described as being performed by the user device 216.

Referring now to FIG. 5, shown therein is a block diagram of an exemplary embodiment of the first network element 204a shown in FIG. 2. However, it should be understood that the description below may be applicable to any of the network elements 204 described herein. As shown in FIG. 5, the first network element 204a—and, therefore, any of the network elements 204 described herein—may comprise one or more of a transmitter 500 and a receiver 504 in addition to a controller 508.

The transmitter 500 may be generally operable to receive outbound baseband signals (i.e., conducted electrical signals) having outbound client data encoded therein from a source external to the transmitter 500 (e.g., the controller 508), generate outbound radiated signals (i.e., radiated electromagnetic waves) based on the outbound baseband signals, and transmit and/or couple the outbound radiated signals into one of the passive waveguides 208 (e.g., the first passive waveguide 208a).

As used herein, “data” refers to quantities, characters, or symbols on which operations are performed by a computer. Data can be recorded on a non-transitory computer readable medium, such as random-access memory and/or read only memory. The random-access memory and/or read only memory may be implemented on semiconductor, magnetic, optical, or mechanical recording media. An example of data is client data, e.g., data provided by a client in connection with a telecommunication service and/or a storage service.

As shown in FIG. 5, the transmitter 500 may comprise a client-side input 512 operable to receive the outbound baseband signals, transmitter circuitry 516 operable to receive the outbound baseband signals from the client-side input 512 and modulate the outbound client data onto a carrier signal having one or more frequencies in a range between 0.1 THz and 10 THz and wavelengths in a range between 3 millimeters (mm) and 30 micrometers (μm) to generate antenna feed signals (also referred to herein as “transmitter output signals”) based on the outbound baseband signals and incorporating the outbound client data configured for coherent detection, and a transmitter antenna array 520 comprising one or more transmitter antennas and operable to receive the antenna feed signals from the transmitter circuitry 516, generate the outbound radiated signals based on the antenna feed signals, and transmit and/or couple the outbound radiated signals into one of the passive waveguides 208 (e.g., the first passive waveguide 208a). In some embodiments, the carrier signals may have a frequency in a different range, such as between 300 Gigahertz (GHz) and 10 THz, for example. The outbound client data can be modulated onto the carrier signal according to a specification of one or more of n-level pulse amplitude modulation (PAMn), m-level quadrature amplitude modulation (mQAM), and quadrature phase shift keying (QPSK). In some embodiments, the one or more transmitter antennas include a metallic radiating element constructed of copper, for example, which does not include a photoconductive element, and is operable to generate the outbound radiated signals without optical excitation.

The receiver 504 may be generally operable to receive, detect, and/or decode inbound radiated signals from one of the passive waveguides 208 (e.g., the first passive waveguide 208a), generate inbound baseband signals based on the inbound radiated signals, and transmit the inbound baseband signals having inbound client data encoded therein to a destination external to the receiver 504 (e.g., the controller 508). As shown in FIG. 5, the receiver 504 may comprise a receiver antenna array 524 comprising one or more receiver antennas and operable to receive, detect, and/or decode the inbound radiated signals from one of the passive waveguides 208 (e.g., the first passive waveguide 208a) and generate antenna output signals (also referred to herein as “receiver input signals”) based on the inbound radiated signals, receiver circuitry 528 operable to receive the antenna output signals from the receiver antenna array 524, demodulate the antenna output signals using a coherent demodulation scheme preferably using a local oscillator signal, generated by the receiver circuitry 528, tuned to the frequency of the carrier signals, and generate inbound baseband signals based on the antenna output signals, and a client-side output 532 operable to receive the inbound baseband signals from the receiver circuitry 528 and send the inbound baseband signals to a destination external to the receiver 504 (e.g., the controller 508). In some embodiments, the one or more receiver antennas include a metallic element constructed of copper, for example, which does not include a photoconductive element, and is operable to receive, detect, and generate electrical signals from the inbound radiated signals passing through one of the passive waveguides 208 without optical excitation or a photovoltaic.

The controller 508 may be generally operable to regulate one or more operating parameters of the transmitter 500, the receiver 504, and/or the first network element 204a and/or send and/or receive signals and/or data to and/or from the transmitter 500 and/or the receiver 504.

Nonexclusive examples of how to make and use the transmitter 500 (including but not limited to the client-side input 512, the transmitter circuitry 516, and the transmitter antenna array 520) and the receiver 504 (including but not limited to the receiver antenna array 524, the receiver circuitry 528, and the client-side output 532) are further described in U.S. patent application Ser. No. 18/927,535, titled “Fiber-Coupled Terahertz RF Transceiver System”, filed on Oct. 25, 2024, the entire content of which is hereby incorporated herein by reference in its entirety.

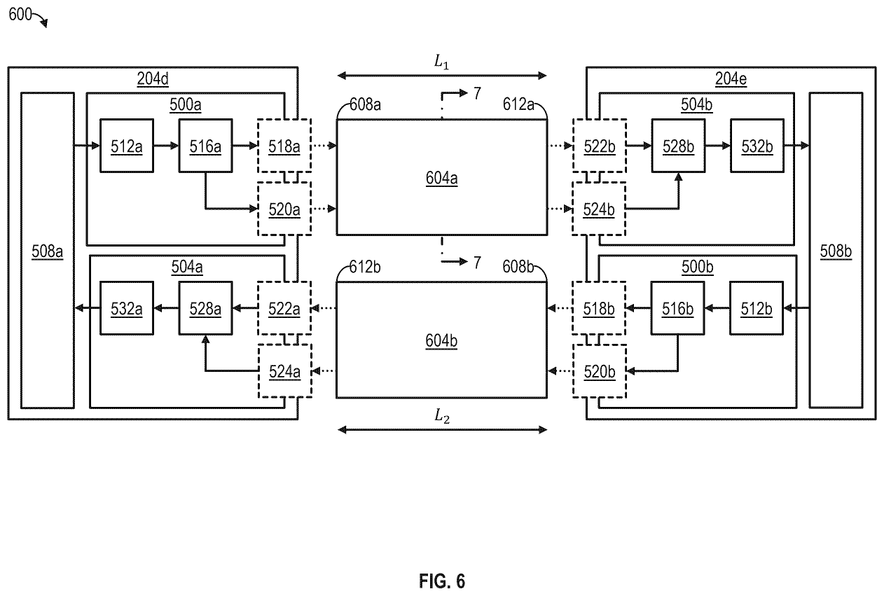

Referring now to FIG. 6, shown therein is an exemplary embodiment of a transport network link 600 constructed in accordance with the present disclosure, comprising a fourth network element 204d and a fifth network element 204e coupled to each other via one or more twinaxial waveguide structures 604a-n (hereinafter the “twinax waveguides 604” or each individually a “twinax waveguide 604”) (e.g., a first twinax waveguide 604a and a second twinax waveguide 604b shown in FIG. 6).

It should be understood that any link in the transport network 200 formed between any two of the network elements 204 may be constructed in a similar manner as the transport network link 600 shown in FIG. 6. Further, while the transport network link 600 is shown in FIG. 6 as being configured for bidirectional communication between the fourth network element 204d and the fifth network element 204e, it should be understood that, in some embodiments, the transport network link 600 may be configured for unidirectional communication from the fourth network element 204d to the fifth network element 204e or vice versa.

For purposes of clarity, signals being transmitted from the fourth network element 204d to the fifth network element 204e are referred to below as being transmitted “downstream”, while signals being transmitted from the fifth network element 204e to the fourth network element 204d are referred to below as being transmitted “upstream”.

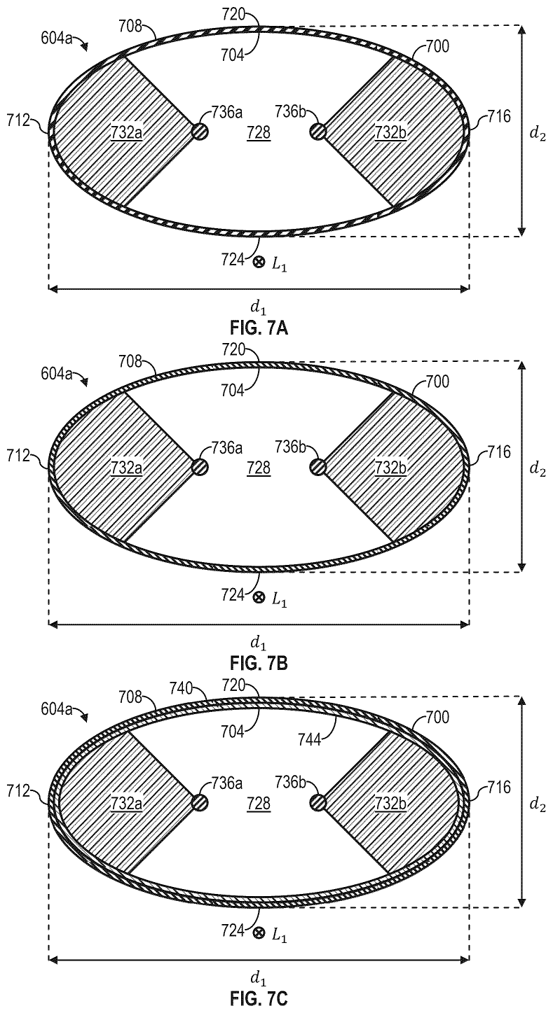

As discussed in more detail below, each of the twinax waveguides 604 may comprise a first conductor 736a (shown in FIG. 7A), a second conductor 736b (shown in FIG. 7A), and a waveguide core 728 (shown in FIG. 7A) extending between the first conductor 736a and the second conductor 736b.

As shown in FIG. 6, the fourth network element 204d may comprise a first transmitter 500a operatively coupled to a first end 608a of the first twinax waveguide 604a, a first receiver 504a operatively coupled to a second end 612b of the second twinax waveguide 604b opposite the first end 608a, and a first controller 508a operatively coupled to the first transmitter 500a and the first receiver 504a, while the fifth network element 204e may comprise a second receiver 504b (the first receiver 504a and the second receiver 504b collectively the “receivers 504”) operatively coupled to a second end 612a of the first twinax waveguide 604a, a second transmitter 500b (the first transmitter 500a and the second transmitter 500b collectively the “transmitters 500”) operatively coupled to a first end 608b of the second twinax waveguide 604b opposite the second end 612b, and a second controller 508b operatively coupled to the second receiver 504b and the second transmitter 500b.

It should be understood that the transmitters 500 and the receivers 504 may be operable to provide and receive electromagnetic signals, respectively, in at least two configurations.

In a first configuration corresponding to one mode of operation, the transmitters 500 may be operable to provide a conducted electromagnetic signal directly to the first conductor 736a and the second conductor 736b of the twinax waveguides 604 (i.e., by providing a first complementary signal component of the conducted electromagnetic signal to the first conductor 736a and a second complementary signal component of the conducted electromagnetic signal to the second conductor 736b), and the receivers 504 may be operable to receive the conducted electromagnetic signal directly from the first conductor 736a and the second conductor 736b of the twinax waveguides 604 (i.e., by receiving the first complementary signal component of the conducted electromagnetic signal from the first conductor 736a and the second complementary signal component of the conducted electromagnetic signal from the second conductor 736b).

In a second configuration corresponding to another mode of operation, the transmitters 500 may be operable to couple a radiated electromagnetic signal into the waveguide core 728 of the twinax waveguides 604, and the receivers may be operable to detect the radiated electromagnetic signal received from the waveguide core 728 of the twinax waveguides 604.

The first transmitter 500a of the fourth network element 204d may comprise a first client-side input 512a operable to receive first outbound baseband signals carrying a first client data from a source external to the first transmitter 500a (e.g., the first controller 508a of the fourth network element 204d) and first transmitter circuitry 516a operable to receive the first outbound baseband signals from the first client-side input 512a and generate first transmitter output signals based on the first outbound baseband signals.

In certain embodiments conforming to the first configuration described above, the first transmitter 500a of the fourth network element 204d may comprise a first electromagnetic feed structure 518a operable to receive the first transmitter output signals from the first transmitter circuitry 516a and directly couple the first transmitter output signals as first conducted electromagnetic signals into the first conductor 736a and the second conductor 736b of the first twinax waveguide 604a (i.e., by providing the first complementary signal component of the first conducted electromagnetic signals to the first conductor 736a of the first twinax waveguide 604a and the second complementary signal component of the first conducted electromagnetic signals to the second conductor 736b of the first twinax waveguide 604a).

In such embodiments, the second receiver 504b of the fifth network element 204e may comprise a second electromagnetic termination structure 522b operable to receive the first conducted electromagnetic signals from the first conductor 736a and the second conductor 736b of the first twinax waveguide 604a (i.e., by receiving the first complementary signal component of the first conducted electromagnetic signals from the first conductor 736a of the first twinax waveguide 604a and the second complementary signal component of the first conducted electromagnetic signals from the second conductor 736b of the first twinax waveguide 604a) and generate first receiver input signals based on the first conducted electromagnetic signals.

In certain embodiments conforming to the second configuration described above, the first transmitter 500a may comprise a first transmitter antenna array 520a comprising one or more first transmitter antennas and being operable to receive the first transmitter output signals from the first transmitter circuitry 516a, generate first outbound radiated signals based on the first transmitter output signals, and couple the first outbound radiated signals as first radiated signals into the first end 608a of the first twinax waveguide 604a.

In such embodiments, the second receiver 504b of the fifth network element 204e may comprise a second receiver antenna array 524b comprising one or more second receiver antennas and being operable to detect the first radiated signals received as first inbound radiated signals from the second end 612a of the first twinax waveguide 604a and generate first receiver input signals based on the first inbound radiated signals.

In either configuration, the second receiver 504b of the fifth network element 204e may comprise second receiver circuitry 528b operable to receive the first receiver input signals from the second electromagnetic termination structure 522b and/or the second receiver antenna array 524b and generate first inbound baseband signals based on the first receiver input signals and a second client-side output 532b operable to receive the first inbound baseband signals from the second receiver circuitry 528b and transmit the first inbound baseband signals to a destination external to the second receiver 504b (e.g., the second controller 508b).

The second transmitter 500b of the fifth network element 204e may comprise a second client-side input 512b operable to receive second outbound baseband signals carrying a second client data from a source external to the second transmitter 500b (e.g., the second controller 508b of the fifth network element 204e) and second transmitter circuitry 516b operable to receive the second outbound baseband signals from the second client-side input 512b and generate second transmitter output signals based on the second outbound baseband signals.

In certain embodiments conforming to the first configuration described above, the second transmitter 500b of the fifth network element 204e may comprise a second electromagnetic feed structure 518b operable to receive the second transmitter output signals from the second transmitter circuitry 516b and directly couple the second transmitter output signals as second conducted electromagnetic signals into the first conductor 736a and the second conductor 736b of the second twinax waveguide 604b (i.e., by providing the first complementary signal component of the second conducted electromagnetic signals to the first conductor 736a of the second twinax waveguide 604b and the second complementary signal component of the second conducted electromagnetic signals to the second conductor 736b of the second twinax waveguide 604b).

In such embodiments, the first receiver 504a of the fourth network element 204d may comprise a first electromagnetic termination structure 522a operable to receive the second conducted electromagnetic signals from the first conductor 736a and the second conductor 736b of the second twinax waveguide 604b (i.e., by receiving the first complementary signal component of the second conducted electromagnetic signals from the first conductor 736a of the second twinax waveguide 604b and the second complementary signal component of the second conducted electromagnetic signals from the second conductor 736b of the second twinax waveguide 604b) and generate second receiver input signals based on the second conducted electromagnetic signals.

In certain embodiments conforming to the second configuration described above, the second transmitter 500b of the fifth network element 204e may comprise a second transmitter antenna array 520b comprising one or more second transmitter antennas and being operable to receive the second transmitter output signals from the second transmitter circuitry 516b, generate second outbound radiated signals based on the second transmitter output signals, and couple the second outbound radiated signals as second radiated signals into the first end 608b of the second twinax waveguide 604b.

In such embodiments, first receiver 504a of the fourth network element 204d may comprise a first receiver antenna array 524a comprising one or more first receiver antennas and being operable to detect the second radiated signals received as second inbound radiated signals from the second end 612b of the second twinax waveguide 604b and generate second receiver input signals based on the second inbound radiated signals.

In either configuration, the first receiver 504a of the fourth network element 204d may comprise first receiver circuitry 528a operable to receive the second receiver input signals from a first electromagnetic termination structure 522a and/or the first receiver antenna array 524a and generate second inbound baseband signals based on the second receiver input signals and a first client-side output 532a operable to receive the second inbound baseband signals from the first receiver circuitry 528a and transmit the second inbound baseband signals to a destination external to the first receiver 504a (e.g., the first controller 508a).

As shown in FIG. 6, the first twinax waveguide 604a may have a first longitudinal axis L₁ extending between the first end 608a and the second end 612a, and the second twinax waveguide 604b may have a second longitudinal axis L₂ extending between the first end 608b and the second end 612b.

In some embodiments, at least one of the first transmitter 500a of the fourth network element 204d and the second transmitter 500b of the fifth network element 204e may be operable to provide the radiated electromagnetic signals such that a guided surface wave is excited in the twinax waveguides 604 that propagates along an interface formed between (i) the surfaces of the first conductor 736a and the second conductor 736b of the twinax waveguides 604 and (ii) the waveguide core 728 of the twinax waveguides 604. In such embodiments, the electromagnetic energy of the guided surface wave may be evanescently confined to a region immediately adjacent to such interface, rather than filling an entire volume of the waveguide core 728 of the twinax waveguides 604.

Referring now to FIG. 7A, shown therein is a cross-sectional view of an exemplary embodiment of the first twinax waveguide 604a shown in FIG. 6, taken along the line 7-7 and in the direction of the arrows. However, it should be understood that any of the twinax waveguides 604—and/or any of the passive waveguides 208—described herein may be constructed in a similar manner as the first twinax waveguide 604a shown in FIG. 7A.

As shown in FIG. 7A, the first twinax waveguide 604a may comprise a sidewall 700 extending between the first end 608a and the second end 612a and having an inner surface 704, an outer surface 708, a first side 712, a second side 716 opposite the first side 712, a third side 720, and a fourth side 724 opposite the third side 720. In some embodiments, the sidewall 700 is a tube. In such embodiments, the inner surface 704 of the sidewall 700 may surround or otherwise define a waveguide core 728 extending between the first end 608a and the second end 612a. The waveguide core 728 may be filled at least partially with a dielectric material, such as air.

A first support 732a may extend between the first end 608a and the second end 612a on the first side 712, and a second support 732b may extend between the first end 608a and the second end 612a on the second side 716. In some embodiments, at least one of the first support 732a and the second support 732b may be constructed of a dielectric material. In at least one embodiment, the dielectric material may be a plastic. The first support 732a may be positioned adjacent to the first side 712 and extend towards the second side 716. The second support 732b may be positioned adjacent to the second side 716 and extend towards the first side 712. In the example shown, the first support 732a and the second support 732b are spaced apart as shown in FIG. 7A.

The first twinax waveguide 604a may further comprise a first conductor 736a extending between the first end 608a and the second end 612a and being supported by the first support 732a and a second conductor 736b extending between the first end 608a and the second end 612 and being supported by the second support 732b. In some embodiments, the waveguide core 728 may be defined as being between the first conductor 736a and the second conductor 736b.

Generally, the first conductor 736a and the second conductor 736b may be spaced a distance apart from each other, as shown in FIG. 7A. Further, the first conductor 736a and the second conductor 736b may not be electrically connected to each other. In some embodiments, the first conductor 736a and the second conductor 736b are electrically isolated from each other.

Generally, the sidewall 700 may be constructed of a material configured to confine the radiated signal propagating within the waveguide core 728. As shown in FIG. 7A, the sidewall 700 may have a first diameter d₁ extending between the first side 712 and the second side 716 and a second diameter d₂ extending between the third side 720 and the fourth side 724. In some embodiments, the sidewall 700 may have a circularly shaped cross-section (i.e., the first diameter d₁ and the second diameter d₂ may be equal in length). However, in other embodiments, the sidewall 700 may have an elliptically shaped cross-section (i.e., the first diameter d₁ and the second diameter d₂ may be unequal in length).

Referring now to FIG. 7B, shown therein is a cross-sectional view of another exemplary embodiment of the first twinax waveguide 604a shown in FIG. 6, taken along the line 7-7 and in the direction of the arrows. However, it should be understood that any of the twinax waveguides 604—and/or any of the passive waveguides 208—described herein may be constructed in a similar manner as the first twinax waveguide 604a shown in FIG. 7B.

In some embodiments, as shown in FIG. 7B, the sidewall 700 may be constructed of a conductive material. In at least one embodiment, the conductive material is a metal.

Referring now to FIG. 7C, shown therein is a cross-sectional view of another exemplary embodiment of the first twinax waveguide 604a shown in FIG. 6, taken along the line 7-7 and in the direction of the arrows. However, it should be understood that any of the twinax waveguides 604—and/or any of the passive waveguides 208—described herein may be constructed in a similar manner as the first twinax waveguide 604a shown in FIG. 7C.

In some embodiments, as shown in FIG. 7C, the sidewall 700 may be a layered structure having a conductive layer 740 constructed of a conductive material and a dielectric layer 744 constructed of a dielectric material. In at least one embodiment, the conductive material of the conductive layer 740 is a metal, and the dielectric material of the dielectric layer 744 is a plastic.

The conductive layer 740 may contact the dielectric layer 744. In some embodiments, the conductive layer 740 may confine the dielectric layer 744. Put another way, in such embodiments, the dielectric layer 744 may be within the confines of the conductive layer 740.

At least one of the conductive layer 740 and the dielectric layer 744 may share the cross-sectional shape of the sidewall 700 shown in FIGS. 7A and 7B. That is, in some embodiments, at least one of the conductive layer 740 and the dielectric layer 744 may have a circularly shaped cross-section. However, in other embodiments, at least one of the conductive layer 740 and the dielectric layer 744 may have an elliptically shaped cross-section.

As described above, in some embodiments, the first twinax waveguide 604a may be configured to guide a surface wave that propagates along an interface formed between (i) the surfaces of the first conductor 736a and the second conductor 736b of the first twinax waveguide 604a and (ii) the waveguide core 728 of the first twinax waveguide 604a. In such embodiments, the electromagnetic energy of the guided surface wave may be evanescently confined to a region immediately adjacent to such interface, rather than filling an entire volume of the waveguide core 728 of the first twinax waveguides 604a.

### ILLUSTRATIVE CLAUSES

Exemplary, non-limiting illustrative clauses are provided in the clauses below. However, the scope of the present inventive concept(s) is to be understood to not be limited in any manner by the clauses presented below.

Illustrative clause 1. A twinaxial waveguide, comprising: a sidewall having a first side, a second side, a first end, a second end, a longitudinal axis extending between the first end and the second end, an outer surface, and an inner surface surrounding a waveguide core extending between the first end and the second end; a first support extending between the first end and the second end on the first side; a second support extending between the first end and the second end on the second side; a first conductor extending along the longitudinal axis between the first end and the second end of the sidewall, the first conductor being supported by the first support; and a second conductor extending along the longitudinal axis between the first end and the second end of the sidewall, the second conductor being supported by the second support; wherein the waveguide core extends between the first conductor and the second conductor.

Illustrative clause 2. The twinaxial waveguide of illustrative clause 1, wherein at least one of the first support and the second support is constructed of a dielectric material.

Illustrative clause 3. The twinaxial waveguide of illustrative clause 2, wherein the dielectric material is a plastic.

Illustrative clause 4. The twinaxial waveguide of illustrative clause 1, wherein the sidewall is constructed of a conductive material.

Illustrative clause 5. The twinaxial waveguide of illustrative clause 1, wherein the waveguide core is at least partially filled with air.

Illustrative clause 6. The twinaxial waveguide of illustrative clause 1, wherein the sidewall is a tube.

Illustrative clause 7. The twinaxial waveguide of illustrative clause 1, wherein the sidewall is a layered structure having a first layer constructed of a conductive material and a second layer constructed of a dielectric material.

Illustrative clause 8. The twinaxial waveguide of illustrative clause 7, wherein the first layer is in contact with the second layer.

Illustrative clause 9. The twinaxial waveguide of illustrative clause 7, wherein the first layer has an elliptically shaped cross-section.

Illustrative clause 10. The twinaxial waveguide of illustrative clause 7, wherein the second layer is within confines of the first layer.

Illustrative clause 11. The twinaxial waveguide of illustrative clause 7, wherein the conductive material is a metal.

Illustrative clause 12. The twinaxial waveguide of illustrative clause 7, wherein the dielectric material is a plastic.

Illustrative clause 13. The twinaxial waveguide of illustrative clause 1, wherein the first conductor and the second conductor are spaced apart from each other.

Illustrative clause 14. The twinaxial waveguide of illustrative clause 1, wherein the first conductor and the second conductor are not electrically coupled to each other.

Illustrative clause 15. The twinaxial waveguide of illustrative clause 1, wherein the first conductor and the second conductor are electrically isolated from each other.

Illustrative clause 16. The twinaxial waveguide of illustrative clause 1, wherein the sidewall further has a third side, a fourth side, a first diameter d_1 extending between the first side and the second side, and a second diameter d_2 extending between the third side and the fourth side, wherein the first diameter d_1 is longer than the second diameter d_2 such that the sidewall has an elliptically shaped cross-section.

Illustrative clause 17. The twinaxial waveguide of illustrative clause 1, wherein the sidewall further has a third side, a fourth side, a first diameter d_1 extending between the first side and the second side, and a second diameter d_2 extending between the third side and the fourth side, wherein the first diameter d_1 is equal to the second diameter d_2 such that the sidewall has a circularly shaped cross-section.

Illustrative clause 18. A transport network, comprising: a twinaxial waveguide, comprising: a sidewall having a first side, a second side, a first end, a second end, a longitudinal axis extending between the first end and the second end, an outer surface, and an inner surface surrounding a waveguide core extending between the first end and the second end; a first support extending between the first end and the second end on the first side; a second support extending between the first end and the second end on the second side; a first conductor extending along the longitudinal axis between the first end and the second end of the sidewall, the first conductor being supported by the first support; and a second conductor extending along the longitudinal axis between the first end and the second end of the sidewall, the second conductor being supported by the second support; wherein the waveguide core extends between the first conductor and the second conductor; a first network element comprising a transmitter operatively coupled to the first end of the twinaxial waveguide, the transmitter being operable to provide an electromagnetic signal to the first end of the twinaxial waveguide; and a second network element comprising a receiver operatively coupled to the second end of the twinaxial waveguide, the receiver being operable to receive the electromagnetic signal from the second end of the twinaxial waveguide.

Illustrative clause 19. The transport network of illustrative clause 18, wherein the transmitter is operable to provide the electromagnetic signal as a conducted electromagnetic signal having a first complementary signal component and a second complementary signal component, the first complementary signal component being provided to the first conductor and the second complementary signal component being provided to the second conductor, and wherein the receiver is operable to receive the conducted electromagnetic signal, the first complementary signal component being received from the first conductor and the second complementary signal component being received from the second conductor.

Illustrative clause 20. The transport network of illustrative clause 18, wherein the transmitter comprises a transmitter antenna array comprising one or more transmitter antennas, the transmitter antenna array being operable to couple the electromagnetic signal as a radiated signal into the waveguide core, and wherein the receiver comprises a receiver antenna array comprising one or more receiver antennas, the receiver antenna array being operable to detect the radiated signal received from the waveguide core, the radiated signal being a radiated electromagnetic wave having a frequency in a range between 300 Gigahertz (GHz) and 10 Terahertz (THz).

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A twinaxial waveguide, comprising:
a sidewall having a first side, a second side, a first end, a second end, a longitudinal axis extending between the first end and the second end, an outer surface, and an inner surface surrounding a waveguide core extending between the first end and the second end;
a first support extending between the first end and the second end on the first side;
a second support extending between the first end and the second end on the second side;
a first conductor extending along the longitudinal axis between the first end and the second end of the sidewall, the first conductor being supported by the first support; and
a second conductor extending along the longitudinal axis between the first end and the second end of the sidewall, the second conductor being supported by the second support;
wherein the waveguide core extends between the first conductor and the second conductor.

2. The twinaxial waveguide of claim 1, wherein at least one of the first support and the second support is constructed of a dielectric material.

3. The twinaxial waveguide of claim 2, wherein the dielectric material is a plastic.

4. The twinaxial waveguide of claim 1, wherein the sidewall is constructed of a conductive material.

5. The twinaxial waveguide of claim 1, wherein the waveguide core is at least partially filled with air.

6. The twinaxial waveguide of claim 1, wherein the sidewall is a tube.

7. The twinaxial waveguide of claim 1, wherein the sidewall is a layered structure having a first layer constructed of a conductive material and a second layer constructed of a dielectric material.

8. The twinaxial waveguide of claim 7, wherein the first layer is in contact with the second layer.

9. The twinaxial waveguide of claim 7, wherein the first layer has an elliptically shaped cross-section.

10. The twinaxial waveguide of claim 7, wherein the second layer is within confines of the first layer.

11. The twinaxial waveguide of claim 7, wherein the conductive material is a metal.

12. The twinaxial waveguide of claim 7, wherein the dielectric material is a plastic.

13. The twinaxial waveguide of claim 1, wherein the first conductor and the second conductor are spaced apart from each other.

14. The twinaxial waveguide of claim 1, wherein the first conductor and the second conductor are not electrically coupled to each other.

15. The twinaxial waveguide of claim 1, wherein the first conductor and the second conductor are electrically isolated from each other.

16. The twinaxial waveguide of claim 1, wherein the sidewall further has a third side, a fourth side, a first diameter d₁ extending between the first side and the second side, and a second diameter d₂ extending between the third side and the fourth side, wherein the first diameter d₁ is longer than the second diameter d₂ such that the sidewall has an elliptically shaped cross-section.

17. The twinaxial waveguide of claim 1, wherein the sidewall further has a third side, a fourth side, a first diameter d₁ extending between the first side and the second side, and a second diameter d₂ extending between the third side and the fourth side, wherein the first diameter d₁ is equal to the second diameter d₂ such that the sidewall has a circularly shaped cross-section.

18. A transport network, comprising:
a twinaxial waveguide, comprising:
a sidewall having a first side, a second side, a first end, a second end, a longitudinal axis extending between the first end and the second end, an outer surface, and an inner surface surrounding a waveguide core extending between the first end and the second end;
a first support extending between the first end and the second end on the first side;
a second support extending between the first end and the second end on the second side;
a first conductor extending along the longitudinal axis between the first end and the second end of the sidewall, the first conductor being supported by the first support; and
a second conductor extending along the longitudinal axis between the first end and the second end of the sidewall, the second conductor being supported by the second support;
wherein the waveguide core extends between the first conductor and the second conductor;
a first network element comprising a transmitter operatively coupled to the first end of the twinaxial waveguide, the transmitter being operable to provide an electromagnetic signal to the first end of the twinaxial waveguide; and
a second network element comprising a receiver operatively coupled to the second end of the twinaxial waveguide, the receiver being operable to receive the electromagnetic signal from the second end of the twinaxial waveguide.

19. The transport network of claim 18, wherein the transmitter is operable to provide the electromagnetic signal as a conducted electromagnetic signal having a first complementary signal component and a second complementary signal component, the first complementary signal component being provided to the first conductor and the second complementary signal component being provided to the second conductor, and wherein the receiver is operable to receive the conducted electromagnetic signal, the first complementary signal component being received from the first conductor and the second complementary signal component being received from the second conductor.

20. The transport network of claim 18, wherein the transmitter comprises a transmitter antenna array comprising one or more transmitter antennas, the transmitter antenna array being operable to couple the electromagnetic signal as a radiated signal into the waveguide core, and wherein the receiver comprises a receiver antenna array comprising one or more receiver antennas, the receiver antenna array being operable to detect the radiated signal received from the waveguide core, the radiated signal being a radiated electromagnetic wave having a frequency in a range between 300 Gigahertz (GHz) and 10 Terahertz (THz).
